(19) United States
(12) Patent Application Publication
(10) Pub. No.: US 2026/0278753 A1
(43) Pub. Date: Sep. 17, 2026

(54) IMAGE INPAINTING METHOD AND APPARATUS, ELECTRONIC DEVICE AND STORAGE MEDIUM

(71) Applicant: Beijing Zitiao Network Technology Co., Ltd., Beijing (CN)

(72) Inventor: Fangyuan KONG, Beijing (CN)

(21) Appl. No.: 19/479,692

(22) PCT Filed: Mar. 12, 2024
(86) PCT No.: PCT/CN2024/081261

§ 371 Date: Oct. 28, 2025

(30) Foreign Application Priority Data
Apr. 28, 2023 (CN) 202310484765.6

(51) Int. Cl. G06T 5/77; G06T 3/147; G06T 5/50

(52) U.S. Cl. CPC G06T 5/77; G06T 3/147; G06T 5/50; G06T 2207/10024; G06T 2207/20221

(57) ABSTRACT

The disclosure relates to an image inpainting method and apparatus, and an electronic device and a storage medium. The image inpainting method includes: identifying a target object in an original image to obtain a target region image; performing inpainting processing on the target region image to obtain a region inpainting image; acquiring a difference image between the region inpainting image and the target region image; and obtaining a target image on the basis of the difference image and the original image. By means of the disclosure, the original image can be inpainted on the basis of the difference image between the region inpainting image and the target area image, thus improving the detail definition and accuracy of the original image, and further improving the capability and stability of image inpainting.

This application claims the benefit of Chinese Patent Application No. 202310484765.6, filed Apr. 28, 2023, entitled “Image Inpainting Method and Apparatus, Electronic Device, and Storage Medium”, the entire contents of which are incorporated herein by reference.

### FIELD

The disclosure relates to the technical field of image processing, and in particular to an image inpainting method and apparatus, an electronic device and a computer readable storage medium.

### BACKGROUND

With the continuous maturity of image processing technology, users have proposed higher requirements on the inpainting effect of image inpainting through image processing technology. Image inpainting refers to a restoration for missing or damaged parts in an image, which is implemented by restoring unknown or damaged information in the image based on the known information in the image.

Taking portrait restoration as an example, the portrait restoration method in the related art has a better inpainting effect only on a portrait photo with a face size of 512×512 (pixel) or less. However, with respect to a portrait photo with a resolution of such as 3024×4032 or more, in which the face size in the portrait photo is much larger than 512×512 (pixel), the reduction (or zooming-out) may lead to a loss of image details when an alignment processing on the human face in the portrait photo is carried out, and the loss may be still presented in the restored portrait photo. Therefore, the detail definition and accuracy of the portrait photo are affected.

### SUMMARY

In view of this, embodiments of the disclosure provide an image inpainting method and apparatus, an electronic device, and a computer-readable storage medium, in order to solve a problem in the related art that, when portrait inpainting is performed on a large-size portrait photo, the loss of image details is caused by zooming-out, thereby affecting the detail definition and accuracy of the portrait photo.

According to a first aspect of an embodiment of the disclosure, there is provided an image inpainting method including: identifying a target object in an original image to obtain a target region image; performing inpainting processing on the target region image to obtain a region inpainting image; acquiring a difference image between the region inpainting image and the target region image; and obtaining a target image based on the difference image and the original image.

According to a second aspect of an embodiment of the disclosure, there is provided an image inpainting apparatus including: an identification module configured to identify a target object in an original image to obtain a target region image; an inpainting module configured to perform inpainting processing on the target region image to obtain a region inpainting image; an acquisition module configured to acquire a difference image between the region inpainting image and the target region image; and a processing module configured to obtain a target image based on the difference image and the original image.

According to a third aspect of an embodiment of the disclosure, there is provided an electronic device including at least one processor; and a memory configured to store at least one processor executable instruction, wherein the at least one processor is configured to execute instructions to implement steps of the method as described above.

According to a fourth aspect of an embodiment of the disclosure, there is provided a computer-readable storage medium, wherein when instruction(s) in the computer-readable storage medium is/are executed by a processor of an electronic device, the electronic device is capable of performing steps of the method as described above

According to a fifth aspect of an embodiment of the disclosure, there is provided a computer program product, the computer program product being tangibly stored in a computer storage medium and including computer executable instructions that, when executed by a device, cause the device to perform steps of the method as described above.

### BRIEF DESCRIPTION OF DRAWINGS

In order to more clearly illustrate the technical solutions in the embodiments of the disclosure, the accompanying drawings, which need to be used in the embodiments or the description of the prior art, are briefly introduced below, and obviously, the drawings in the following description are merely some embodiments of the disclosure, and for those of ordinary skill in the art, other drawings may be obtained according to these drawings without creative work.

FIG. 1 is a flowchart of an image inpainting method according to an exemplary embodiment of the disclosure.

FIG. 2 is a flowchart of an image inpainting method according to an exemplary embodiment of the disclosure.

FIG. 3a to FIG. 3g are schematic diagrams of an image inpainting process according to an exemplary embodiment of the disclosure.

FIG. 4 is a schematic block diagram of functional modules of an image inpainting apparatus according to an exemplary embodiment of the disclosure.

FIG. 5 is a structural block diagram of an electronic device according to an exemplary embodiment of the disclosure.

FIG. 6 is a structural block diagram of a computer system according to an exemplary embodiment of the disclosure.

### DETAILED DESCRIPTION

Embodiments of the disclosure will be described in more detail below with reference to the accompanying drawings. While certain embodiments of the disclosure are shown in the drawings, it is to be understood that the disclosure may be implemented in various forms, and should not be construed as limited to the embodiments set forth herein, and vice versa. It should be understood that the drawings and embodiments of the disclosure are for exemplary purposes only and are not intended to limit the scope of the disclosure.

It should be understood that the steps recited in the method embodiments of the disclosure may be performed in different orders, and/or in parallel. Further, the method embodiments may include additional steps and/or omit performing the illustrated steps. The scope of the disclosure is not limited in this respect.

As used herein, the term “comprising” and variations thereof are open-ended, i.e., “including but not limited to”. The term “based on” is “based at least in part on”. The term “one embodiment” means “at least one embodiment”; the term “another embodiment” means “at least one further embodiment”; the term “some embodiments” means “at least some embodiments”. The relevant definitions of other terms will be given below. It should be noted that the concepts such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in this disclosure is illustrative and not limiting, and those skilled in the art should understand that they should be understood as “one or more” unless the context clearly indicates otherwise.

The names of messages or information exchanged between multiple devices in embodiments of the disclosure are for illustrative purposes only and are not intended to limit the scope of such messages or information.

It can be understood that, before the technical solutions disclosed in the embodiments of the disclosure are used, the types of personal information related to the disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Thus, the user can autonomously select whether to provide personal information to software or hardware executing the operation of the technical solution of the disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on implementations of the disclosure, and other manners of meeting related laws and regulations may also be applied to implementations of the disclosure.

With the continuous maturity of image processing technology, users have proposed higher requirements on the inpainting effect of image inpainting through the image processing technology, and the imaging quality of photos has become one of primary focuses. Since the imaging quality of a photo is affected by external environment and/or physical factors, there is an increasing attention on the inpainting technology. The inpainting technology is a technology capable of improving the details and definition of photos, and can restore the details of the photos that are seriously damaged or have poor definition to a certain extent. The application scenario of the inpainting technology is very extensive, for example, inpainting a picture shot by an early image shooting device, inpainting a picture rephotographed or scanned by multiple times, inpainting a picture reprinted and compressed for multiple times on the web, and inpainting a picture shot by a surveillance camera having low-definition.

In the related art, the portrait inpainting method includes: detecting a face and a facial feature point in the original portrait photo by using a face detection algorithm, and performing alignment processing on the face based on the positions of the facial feature points, namely, cropping an image region where the face is located into a specified size, for example, by 512×512 (pixel), to obtain an aligned portrait photo; then, inputting the aligned portrait photo into a portrait inpainting model to obtain an inpainted portrait photo; and finally, rotating the inpainted portrait photo, zooming it to a size of the original portrait photo, and adding it to the original portrait photo. Such a portrait inpainting method has better inpainting effect only on a portrait photo with a face size of 512×512 or less, and however, for a portrait photo with a resolution of such as 3024×4032 or more, in which the face size in the portrait photo is much larger than 512×512 (pixel), the reduction (or zooming-out) may lead to a loss of image details when an alignment processing on the human face in the portrait photo is carried out, and the loss may be still presented in the restored portrait photo, and thus, the detail definition and accuracy of the portrait photo are affected.

An image inpainting method and apparatus according to an embodiment of the disclosure will be described in detail below with reference to the accompanying drawings.

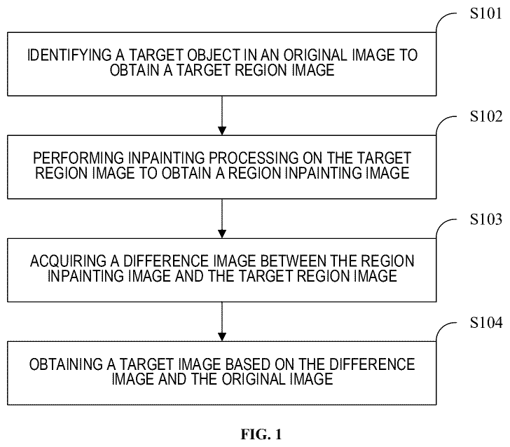

FIG. 1 is a flowchart of an image inpainting method according to an exemplary embodiment of the disclosure. The image inpainting method in FIG. 1 may be performed by a server or an electronic device. As shown in FIG. 1, the image inpainting method includes:
S101, identifying a target object in an original image to obtain a target region image;
S102, performing inpainting processing on the target region image to obtain a region inpainting image;
S103, acquiring a difference image between the region inpainting image and the target region image;
S104, obtaining a target image based on the difference image and the original image.

Specifically, taking the server as an example, after receiving the image inpainting request, the server identifies the target object in the original image by using an image identification technology to determine a target region image of the target object, and performs inpainting processing on the target region image to obtain a region inpainting image; further, the server acquires a difference image between the region inpainting image and the target region image, and obtains a target image based on the difference image and the original image.

Here, the server may be a standalone physical server, or may be a server cluster or a distributed system composed of a plurality of physical servers, or may be a cloud server that provides basic cloud computing services such as cloud services, cloud databases, cloud computing, cloud functions, cloud storage, network services, cloud communications, middleware services, domain name services, security services, content delivery networks (CDN), and big data and artificial intelligence platforms, which is not limited in the embodiments of the disclosure.

The image identification refers to a technology of processing, analyzing and understanding an image to be identified by using a computer to identify targets and objects in different modes included in an image to be identified, and is a practical application for a deep learning algorithm. The image identification may include face identification, item identification, distance detection, and the like. Face identification may be applied to the fields of security check, identity verification and the like, item identification may be applied to the fields of intelligent retail and the like, and distance detection may be applied to the fields of object tracking and the like.

The original image refers to an image obtained by directly shooting a real scene by using an image acquisition device. Here, the image acquisition device may include, but is not limited to, a camera, a video camera, and the like. In the embodiments of the disclosure, the original image refers to an image on which image inpainting is required. Preferably, the original image is a high-resolution image or a super-resolution image. Herein, the high-resolution image is also referred to as a high-definition image, and refers to an image with a vertical resolution greater than or equal to 720, for example, 1280×720, 1920×1080, etc., where a width (i.e., a horizontal resolution) is represented in front of “×”, and a height (i.e., a vertical resolution) is represented behind “×”. It should be noted that, the original image may be obtained by the image acquisition device, or may be collected based on a currently disclosed image library in the Internet, which is not limited in the embodiments of the disclosure.

The target object refers to an object or a subject in an original image. The target object may include a person, an animal, a plant, a building, an item, etc., which is not limited in the embodiments of the disclosure. The target region image refers to an image of a region where the target object in the original image is located.

The image inpainting is a process of reconstructing a lost or damaged part in an image or video, and some noises, scratches, deletions and occlusions in the image may be removed by using an image inpainting technology, thereby improving image quality. The image inpainting is inpainting the target object based on Generative Adversarial Nets (GANs) or Diffusion Model. The region inpainting image refers to an inpainted image obtained by inpainting a target region image by using an image inpainting technology.

The difference refers to a difference point between two images. The difference image refers to a scatter diagram with some difference as the ordinate and other suitable amounts as the abscissa. In the embodiments of the disclosure, the difference image refers to a deviation between the region inpainting image and the target region image, that is, the difference image is used to represent a difference between the region inpainting image and the target region image.

According to the technical solution provided by the embodiment of the disclosure, the target object in the original image is identified to obtain the target region image, the target region image is inpainted to obtain the region inpainting image, the difference image between the region inpainting image and the target region image is acquired, and the target image is obtained based on the difference image and the original image, and the original image can be inpainted based on the difference image between the region inpainting image and the target region image. In this way, the detail definition and accuracy of the original image are improved, and the image inpainting capability and stability are further improved.

In some embodiments, the identifying the target object in the original image to obtain the target region image includes: detecting the target object in the original image; generating an initial region image based on an image region where the target object is located; detecting key points in the initial region image to obtain key point information; and performing alignment processing on the target object based on the key point information to obtain the target region image.

Specifically, image detection is performed on the original image to determine whether the target object exists in the original image; when it is detected that the target object exists in the original image, the image region where the target object is located may be determined based on a position of the target object in the original image, and the initial region image is generated based on the image region where the target object is located; further, key point detection is performed on the key points in the initial region image, and alignment processing is performed on the target object based on the detected key point information to obtain the target region image.

Herein, the image detection refers to processing an image by using computer vision and the like, thereby identifying and selecting various types of objects in the image. An image detection algorithm may include an image detection algorithm based on a cascade classifier framework, an image detection algorithm based on template matching, an image detection algorithm based on regression, and the like, which is not limited in the embodiments of the disclosure.

The initial region image refers to an image generated based on an image region where the target object is located in the original image. Taking the target object being a face as an example, the image region where the target object is located refers to the image region where the face is located in the original image, that is, a face region. In order to locate the face region to obtain a position information corresponding to the face region, a face detection algorithm may be used to detect the face in the original image and acquire a face point set; further, the circumscribed rectangle of the face shape represented by the face point set is calculated, and the cropped rectangle of the face may be obtained by expanding outwards, that is, the face region is extracted separately from the original image to generate the initial region image. Here, the position information corresponding to the face region is used to represent coordinates of the face position, and the face point set is used to represent information such as a posture, a position, a face shape and the like of the face in the image. The initial region image refers to a cropped face image obtained by cropping the original image, for example, subtracting redundant parts other than the face in the original image.

It should be noted that, if the face in the original image is not horizontal, for example, with tilted head or upturned head, lying down, etc., the obtained cropped rectangle is also not horizontal, and therefore, it is necessary to compare the cropped rectangle with a preset standard rectangle to determine a rotation angle of the face in the original image with respect to the horizontal direction. Here, the preset standard rectangle may be a preset horizontal standard rectangle.

In order to make the obtained crop rectangle horizontal, the key point detection may be performed on the key points in the initial region image, and a position relationship of the key points in the initial region image is obtained by using an affine transformation method based on the detected coordinates of the key points; further, the position relationship of the key points in the initial region image is aligned with a position relationship of key points in a standard front face to obtain the aligned face image, that is, the target region image.

Here, the key point refers to a key part capable of representing the target object. For example, when the target object is a human, the key point may be a facial landmark such as eyebrows, eyes, nose, mouth, etc. ; when the target object is a small dog, the key point may be a mark part such as a tail, a limb, and an ear. The key point information may include, but is not limited to, coordinates and confidences of the key points. The key point detection refers to a detection for key region position(s) capable of locating the key points. The key point detection algorithm may include an Active Shape Model (ASM) algorithm, an Active Appearance Model (AAM) algorithm, a Cascaded Pose Regression (CPR) algorithm, a Deep Learning (DL) algorithm, and the like, which is not limited in the embodiments of the disclosure.

The alignment processing refers to correcting an angle of the target object in the image. The target object in the original image may be tilted at an angle, and the target object may be placed properly on the image through the alignment processing, so as to facilitate the subsequent identification processing on the image. The alignment algorithm may include a scaling rotation algorithm, an affine transformation algorithm, and the like, which is not limited in the embodiments of the disclosure.

According to the technical solution provided by the embodiment of the disclosure, the initial region image is generated based on the image region where the detected target object is located, the key points in the initial region image are detected, and the target object is aligned based on the detected key point information, so that the target object having a non-horizontal angle being detected can be angle-corrected, thereby eliminating errors due to different postures, and improving the accuracy of the subsequent image inpainting.

In some embodiments, the performing alignment processing on the target object based on the key point information to obtain the target region image includes: rotating the initial region image based on the key point information; and adjusting a size of the rotated initial region image to a preset size to obtain the target region image.

Specifically, after the key point information is acquired, the initial region image may be rotated based on the key point information to correct the angle of the target object in the initial region image; further, the rotated initial region image is compressed and/or cropped to obtain the target region image with the preset size.

Here, the preset size may be preset according to actual needs, for example, the preset size may be in a pixel ratio of 64×64, 128×128, 160×160, 200×200, 224×224, etc., which is not limited in the embodiments of the disclosure. The target region image refers to a preset size image obtained by adjusting the size of the rotated initial region image. It should be understood that the size of the target region image is the same as the preset size, for example, the preset size is 128×128 (pixel), and then the size of the target region image is also 128×128 (pixel).

In some embodiments, the performing alignment processing on the target region image to obtain the region inpainting image includes: inputting the target region image into an image inpainting model to obtain the region inpainting image.

Specifically, after acquiring the target region image, the target region image may be used as an input of the image inpainting model, and the image inpainting model is used to perform image inpainting on the target region image to obtain the region inpainting image.

Here, the image inpainting model is a generator in the generative adversarial net, including an encoding network and a decoding network, wherein the encoding network is configured to extract image features, and the decoding network is configured to restore the image. The image inpainting model may be obtained by using a deep learning algorithm, and the deep learning algorithm may include convolutional neural networks (CNNs) of various structures, which is not limited in the embodiments of the disclosure.

The image inpainting model is configured to perform image inpainting on the low-quality image. Specifically, the low image quality image data set is input into the to-be-trained image inpainting model, and the image inpainting model inpaints the image through the processing of the encoding network and the decoding network to obtain a training generation image corresponding to the low image quality image, so as to form the training generation image data set; further, the image inpainting quality of the training generation image is continuously improved by continuously adjusting network parameters of the image inpainting model.

In an embodiment of the disclosure, the image inpainting model is obtained by training a neural network model several times based on a sample image, the sample image may include an image that meets a screening condition, and the neural network model may be a convolutional neural network model. Herein, the image that meets the screening condition may include an image after data disturbance, and the data disturbance may include at least one of noise, mosaic, and blur. For example, the image is a high-quality image, noise, mosaic, blur and the like are applied on the high-quality image to reduce the data disturbance of image quality, and the obtained image is an image that meets the screening condition. It should be noted that the high-quality image is a high-definition image without noise.

According to the technical solution provided by the embodiment of the disclosure, the image inpainting model is used to perform image inpainting on the target region image, so that the region inpainting image with higher image quality can be obtained, and thus, the accuracy of the subsequent difference calculation is improved.

In some embodiments, the acquiring the difference image between the region inpainting image and the target region image includes: performing difference processing on pixel values of the region inpainting image and the target region image based on a position of pixel points to obtain the difference image, where the pixel value includes one or more of an RGB value, a UV value, and a brightness value.

Specifically, after obtaining the region inpainting image and the target region image, the pixel values of pixels in the region inpainting image and the target region image may be further obtained, and difference processing is performed on the pixel values corresponding to the pixels in the region inpainting image and the pixel values of the corresponding pixel points in the target region image based on the positions of the pixel points, that is, the difference between the pixel point pairs is calculated, to obtain the difference image.

Here, the pixel pair refers to pixel points matched with each other in the two images. In the embodiments of the disclosure, the pixel pairs refer to pixels in one-to-one correspondence in the target region image and the region inpainting image. Since a resolution of the region inpainting image is same as a resolution of the region inpainting image, that is, the pixel points in the region inpainting image and the region inpainting image are in a one-to-one correspondence, the difference between each pair of pixel points may be calculated when the difference is calculated, and all the obtained differences may form an image, that is, the difference image.

Optionally, when calculating the difference, since the difference is an integer type in a range of [−255, 255], the difference may be converted into and presented as a numerical type with low precision, for example, by setting an offset, the difference of the pixel points is distributed around 128, so that the data is more concentrated.

According to the technical solution provided by the embodiment of the disclosure, the difference between each pair of pixel points in the region inpainting image and the target region image may be accurately calculated through a pixel point-to-point subtraction operation on the region inpainting image and the target region image, so that the difference between the region inpainting image and the target region image is clearly determined, thereby improving the accuracy of the subsequent image fusion.

In some embodiments, the obtaining the target image based on the difference image and the original image includes: performing inverse rotation on the difference image; adjusting a size of the inverse-rotated difference image to an original image size to obtain an adjusted difference image; and fusing the adjusted difference image and the original image to obtain the target image.

Specifically, after the difference image is acquired, inverse rotation may be performed on the difference image, and the size of the inverse-rotated difference image may be adjusted to the size of the original image to obtain the adjusted difference image; further, the adjusted difference image is fused with the original image to obtain the target image.

Here, the inverse rotation is an inverse operation of the rotation process as described above, and a magnitude of an angle of the inverse rotation is consistent with that of an angle of the rotation process. That is, if the initial region image is rotated, the difference image is subjected to the inverse rotation. For example, if the initial region image is rotated by 30° to the left when rotated, the difference image is rotated to the right by 30°.

The image fusion refers to fusing pixel values of pixels at the same position in at least two images. The fusion of the pixel values may includes, but is not limited to, at least one of a weighted calculation or a summation calculation on the pixel values. The target image refers to an image finally generated after image fusion is performed on the adjusted difference image and the original image.

According to the technical solution provided by the embodiment of the disclosure, the difference image is subjected to inverse rotation and adjustment, so that the angle and the position of the adjusted difference image may be kept consistent with the angle and the position of the original image.

In some embodiments, fusing the adjusted difference image and the original image to obtain the target image includes: performing addition processing on pixel values of the adjusted difference image and the original image based on the position of the pixels to obtain the target image, where the pixel value includes one or more of an RGB value, a UV value, and a brightness value.

Specifically, after the adjusted difference image is obtained, the pixel values of the pixel points in the adjusted difference image and the original image may be obtained, and addition processing is performed on the pixel value of each of the pixel points in the adjusted difference image and the pixel value of the corresponding pixel point in the original image based on the position of the pixel points to obtain the target image.

Here, the pixel point pair refers to pixel points that are correspond to each other one by one in the original image and the adjusted difference image. Since the original image and the adjusted difference image have the same resolution, after obtaining the pixel values corresponding to the pixel points in the adjusted difference image, they may be added to the original image, that is, the image fusion is performed on the adjusted difference image and the original image, thereby enhancing the pixel values corresponding to the pixel points in the original image to obtain the enhanced image corresponding to the original image. That is, the addition processing is performed on the pixel value corresponding to each pixel point (i.e., the image pixel) and the original pixel value, and the image that is subjected to the addition processing may be determined as the target image.

The image addition operation is mainly applied to superimpose the contents of one image onto another image to generate a superimposed image effect, or add a constant to each pixel in the image to change the brightness of the image. In the embodiment of the disclosure, the addition processing refers to a point-to-point addition operation between the pixel value of each pixel point in the adjusted difference image and the pixel value of the corresponding pixel point in the original image.

According to the technical solution provided by the embodiment of the disclosure, the original image is inpainted by using the adjusted difference image, the detail definition of the original image can be improved, and therefore, the detail retention after the high-resolution image is inpainted is realized.

All the foregoing optional technical solutions may be combined to form an optional embodiment of the disclosure, and details are not described herein again. In addition, the sequence numbers of the steps in the above embodiments do not mean the order of execution, and the order of execution of processes should be determined by their functions and internal logic, and should not constitute any limitation on the implementation process of the embodiments of the disclosure.

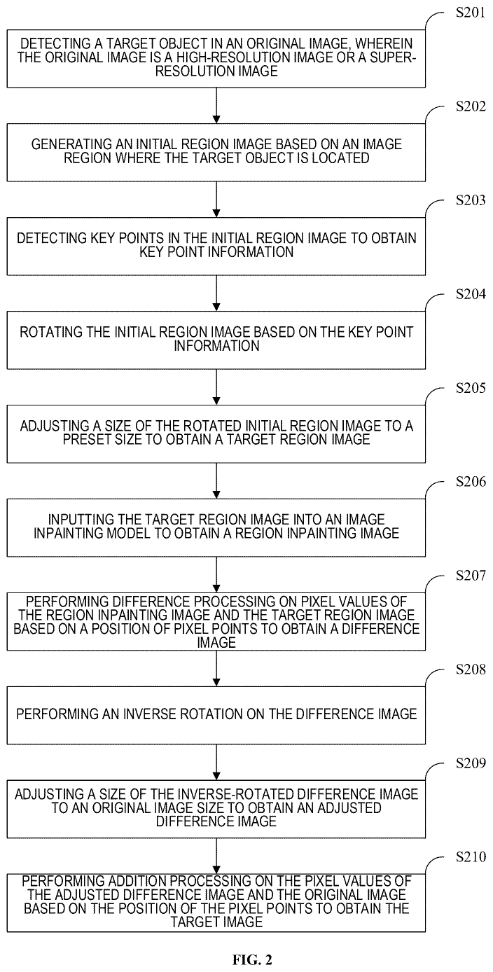

FIG. 2 is a flowchart of an image inpainting method according to an exemplary embodiment of the disclosure. The image inpainting method in FIG. 2 may be performed by a server or an electronic device. As shown in FIG. 2, the image inpainting method includes:
S201, detecting a target object in an original image, wherein the original image is a high-resolution image or a super-resolution image;
S202, generating an initial region image based on an image region where the target object is located;
S203, detecting key points in the initial region image to obtain key point information;
S204, rotating the initial region image based on the key point information;
S205, adjusting a size of the rotated initial region image to a preset size to obtain a target region image;
S206, inputting the target region image into an image inpainting model to obtain a region inpainting image;
S207, performing difference processing on pixel values of the region inpainting image and the target region image based on a position of pixel points to obtain a difference image;
S208, performing an inverse rotation on the difference image;
S209, adjusting a size of the inverse-rotated difference image to an original image size to obtain an adjusted difference image;
S210, performing addition processing on the pixel values of the adjusted difference image and the original image based on the position of the pixel points to obtain the target image.

According to the technical solution provided by the embodiment of the disclosure, the difference value between the target region image obtained by performing detection and alignment processing on the original image and the region inpainting image obtained by inpainting the target region image is calculated, and the original image is inpainted based on the difference value, improving the detail definition of the original image, ang thereby achieving the detail retention after the high-resolution image is inpainted, and further improving the image inpainting capability and stability.

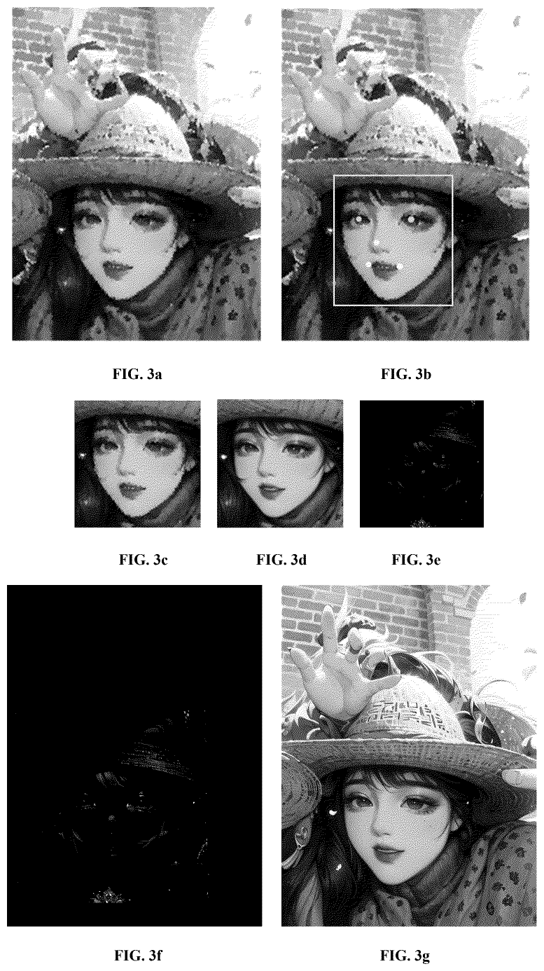

FIG. 3a to FIG. 3g are schematic diagrams of an image inpainting process according to an exemplary embodiment of the disclosure. The image inpainting method provided in the embodiments of the disclosure will be described in detail below with reference to FIG. 3a to FIG. 3g.

In particular, FIG. 3a is a high-resolution original image. Firstly, a target object (for example, a human face) in an original image is detected, and an initial region image is generated based on the image region where the detected target object is located, as shown in FIG. 3b; continuing, key points in the initial region image are detected to obtain key point information, the initial region image is rotated based on the detected key point information, and the rotated initial region image is cropped to obtain a target region image, as shown in FIG. 3c; sequentially the target region image is put into an image inpainting model to obtain a region inpainting image, as shown in FIG. 3d, and difference processing is performed on the pixel values of the region inpainting image and the target region image based on the position of the pixel points to obtain a difference image, as shown in FIG. 3e; further, inverse rotation is performed on the difference image, and a size of the inverse-rotated difference image is adjusted to an original image size to obtain an adjusted difference image, as shown in FIG. 3f; and finally, the addition processing is performed on the pixel values of the adjusted difference image and the original image based on the position of the pixel points to obtain a target image, as shown in FIG. 3g.

The at least one of the technical solutions adopted in the embodiments of the disclosure can achieve the following beneficial effects, that is, by identifying a target object in an original image to obtain a target region image, performing inpainting processing on the target region image to obtain a region inpainting image, acquiring a difference image between the region inpainting image and the target region image, and obtaining a target image based on the difference image and the original image, the original image can be inpainted based on the difference image between the region inpainting image and the target region image, thereby improving the detail definition and accuracy of the original image, and further improving the image inpainting capability and stability.

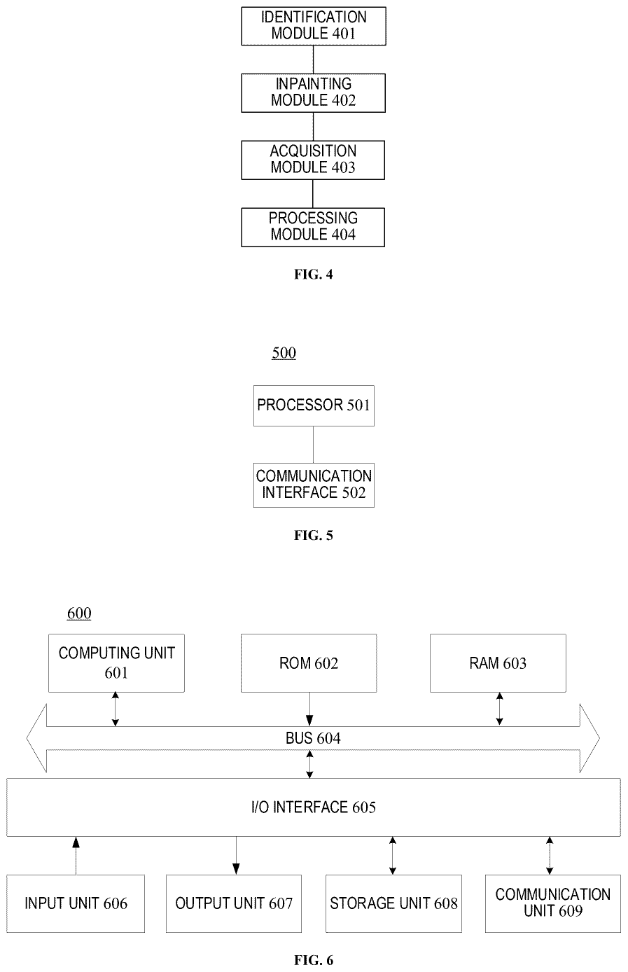

In a case that functional modules are divided according to corresponding functions, the embodiments of the disclosure provide an image inpainting apparatus, which may be a server or a chip applied to a server. FIG. 4 is a schematic block diagram of functional modules of an image inpainting apparatus according to an exemplary embodiment of the disclosure. As shown in FIG. 4, the image inpainting apparatus includes:
an identification module 401 configured to identify a target object in an original image to obtain a target region image;
an inpainting module 402 configured to perform inpainting processing on the target region image to obtain a region inpainting image;
an acquisition module 403 configured to acquire a difference image between the region inpainting image and the target region image;
a processing module 404 configured to obtain a target image based on the difference image and the original image.

According to the technical solution provided by the embodiment of the disclosure, by identifying a target object in an original image to obtain a target region image, performing inpainting processing on the target region image to obtain a region inpainting image, acquiring a difference image between the region inpainting image and the target region image, and obtaining a target image based on the difference image and the original image, the original image can be inpainted based on the difference image between the region inpainting image and the target region image, thereby improving the detail definition and accuracy of the original image, and further improving the image inpainting capability and stability.

In some embodiments, the identification module 401 of FIG. 4 is configured to detect the target object in the original image; generate the initial region image based on the image region where the target object is located; detect the key points in the initial region image to obtain key point information; and perform alignment processing on the target object based on the key point information to obtain the target region image.

In some embodiments, the identification module 401 of FIG. 4 is configured to rotate the initial region image based on the key point information; and adjust a size of the rotated initial region image to a preset size to obtain the target region image.

In some embodiments, the inpainting module 402 of FIG. 4 is configured to input the target region image into the image inpainting model to obtain the region inpainting image.

In some embodiments, the acquisition module 403 of FIG. 4 is configured to perform difference processing on the pixel values of the region inpainting image and the target region image based on the position of the pixel points to obtain the difference image. The pixel value includes one or more of an RGB value, a UV value, and a brightness value.

In some embodiments, the processing module 404 of FIG. 4 is configured to perform inverse rotation on the difference image; adjust a size of the inverse-rotated difference image is to the original image size to obtain an adjusted difference image; and fusing the adjusted difference image with the original image to obtain the target image.

In some embodiments, the processing module 404 of FIG. 4 is configured to perform addition processing on the pixel values of the adjusted difference image and the original image based on the position of the pixel points to obtain the target image. The pixel value includes one or more of an RGB value, a UV value, and a brightness value.

In some embodiments, the original image is a high-resolution image or a super-resolution image.

The implementation processes of functions and effects of various modules in the foregoing apparatus are described in detail with reference to the implementation processes of corresponding steps in the foregoing method, and details thereof will not be described herein again.

An embodiment of the disclosure further provides an electronic device, including: at least one processor; a memory configured to store at least one processor-executable instruction; wherein the at least one processor is configured to execute instructions to implement steps of the image inpainting method as disclosed in the embodiments of the disclosure.

FIG. 5 is a schematic structural diagram of an electronic device according to an exemplary embodiment of the disclosure. As shown in FIG. 5, the electronic device 500 includes at least one processor 501 and a memory 502 coupled to the processor 501. The processor 501 may perform the corresponding steps of the method as described in the embodiments of the disclosure.

The processor 501 may also be referred to as a central processing unit (CPU), and may be an integrated circuit chip, and has a signal processing capability. The steps in the foregoing method as disclosed in the embodiments of the disclosure may be completed by an integrated logic circuit of hardware in the processor 501 or instruction(s) in a form of software. The processor 501 may be a general-purpose processor, a digital signal processor (DSP), an ASIC, a field-programmable gate array (FPGA) or another programmable logic device, a discrete gate or transistor logic device, or a discrete hardware component. The general purpose processor may be a microprocessor, or the processor may be any conventional processor or the like. The steps of the method as disclosed in the embodiments of the disclosure may be directly embodied to be performed by a hardware decoding processor, or performed by a combination of hardware and software modules in the decoding processor. The software module may be located in the memory 502, for example, a random memory, a flash memory, a read-only memory, a programmable read-only memory, an electrically erasable programmable memory, a register, or a mature storage medium in the art. The processor 501 reads the information in the memory 502, and completes the steps of the foregoing method in combination with hardware thereof.

In addition, in the case that various operations/processes according to the disclosure are implemented by software and/or firmware, a program constituting the software may be installed from a storage medium or a network to a computer system having a dedicated hardware structure, for example, the computer system 600 shown in FIG. 6, and when various programs are installed, the computer system may perform various functions, including functions such as those described above. FIG. 6 is a structural block diagram of a computer system according to an exemplary embodiment of the disclosure.

The computer system 600 is intended to represent various forms of digital electronic computer devices, such as laptop computers, desktop computers, workstations, personal digital assistants, servers, blade servers, mainframe computers, and other suitable computers. The electronic device may also represent various forms of mobile devices, such as personal digital processing, cellular telephones, smart phones, wearable devices, and other similar computing devices. The components shown herein, their connections and relationships, and their functions are by way of example only and are not intended to limit the implementations of the disclosure described and/or claimed herein.

As shown in FIG. 6, the computer system 600 includes a computing unit 601, which may perform various appropriate actions and processes according to a computer program stored in a read-only memory (ROM) 602 or a computer program loaded into a random access memory (RAM) 603 from a storage unit 608. In the RAM 603, various programs and data required by the operation of the computer system 600 may also be stored. The computing unit 601, the ROM 602, and the RAM 603 are connected to each other through a bus 604. The input/output (I/O) interface 605 is also connected to bus 604.

Components in the computer system 600 are connected to the I/O interface 605, including: an input unit 606, an output unit 607, a storage unit 608, and a communication unit 609. The input unit 606 may be any type of device capable of inputting information to the computer system 600, the input unit 606 may receive input numeric or character information, and generate key signal input related to user settings and/or function control of the electronic device. The output unit 607 may be any type of device capable of presenting information and may include, but is not limited to, a display, a speaker, a video/audio output terminal, a vibrator, and/or a printer. The storage unit 608 may include, but is not limited to, a magnetic disk and an optical disk. The communication unit 609 allows the computer system 600 to exchange information/data with other devices over a network, such as the Internet, and may include, but is not limited to, a modem, a network card, an infrared communication device, a wireless communication transceiver, and/or a chipset, such as a Bluetooth TM device, a WiFi device, a WiMax device, a cellular communication device, and/or the like.

The computing unit 601 may be a variety of general-purpose and/or special-purpose processing components with processing and computing capabilities. Some examples of the computing unit 601 include, but are not limited to, a central processing unit (CPU), a graphics processing unit (GPU), various specialized artificial intelligence (AI) computing chips, various computing units running machine learning model algorithms, digital signal processors (DSPs), and any suitable processor, controller, microcontroller, or the like. The computing unit 601 performs the various methods and processes described above. For example, in some embodiments, the above method disclosed in the embodiments of the disclosure may be implemented as a computer software program, which is tangibly included in a machine-readable medium, such as the storage unit 608. In some embodiments, some or all of the computer programs may be loaded and/or installed onto the electronic device 600 via the ROM 602 and/or the communication unit 609. In some embodiments, the computing unit 601 may be configured to perform the above method disclosed in the embodiments of the disclosure in any other suitable manner (for example, by means of firmware).

An embodiment of the disclosure further provides a computer-readable storage medium, where the instructions in the computer-readable storage medium, when executed by a processor of the electronic device, enable the electronic device to perform the foregoing method disclosed in the embodiments of the disclosure.

The computer-readable storage medium in embodiments of the disclosure may be a tangible medium that may contain or store a program for use by or in connection with an instruction execution system, apparatus, or device. The computer-readable storage medium described above may include, but is not limited to, electronic, magnetic, optical, electromagnetic, infrared, or semiconductor systems, apparatuses, or devices, or any suitable combination of the foregoing. More specifically, the computer-readable storage medium described above may include an electrical connection based on one or more lines, a portable computer disk, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing.

The computer-readable medium described above may be included in the electronic device; or may be separately present without being assembled into the electronic device.

An embodiment of the disclosure further provides a computer program product, including a computer program, wherein when the computer program is executed by a processor, the foregoing method disclosed in the embodiments of the disclosure is implemented.

In embodiments of the disclosure, computer program code for performing the operations of the disclosure may be written in one or more programming languages, including, but not limited to, object oriented programming languages, such as Java, Smalltalk, C++, and conventional procedural programming languages, such as “C” languages or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer.

The flowcharts and block diagrams in the figures illustrate architecture, functionality, and operation of possible implementations of systems, methods, and computer program products according to various embodiments of the disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The modules, components, or units involved in the embodiments of the disclosure may be implemented in software, or may be implemented in hardware. A name of a module, component, or unit in some cases does not constitute limitation on the module, component, or unit itself.

The functions described above may be performed, at least in part, by one or more hardware logic components. For example, without limitation, exemplary hardware logic components that may be used include: a field-programmable gate array (FPGA), an application-specific integrated circuit (ASIC), an application-specific standard product (ASSP), a system-on-a-chip (SOC), a complex programmable logic device (CPLD), or the like.

The above description is only some embodiments of the disclosure and description of the principles of the applied technology. It should be understood by those skilled in the art that the disclosure scope involved in the disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the disclosure (but not limited to).

Although some specific embodiments of the disclosure have been described in detail by way of example, those skilled in the art should understand that the above examples are for illustration only and are not intended to limit the scope of the disclosure. It should be understood by those skilled in the art that modifications to the above embodiments may be made without departing from the scope and spirit of the disclosure. The scope of the disclosure is defined by the appended claims.

1-12. (canceled)

13. An image inpainting method, comprising:
identifying a target object in an original image to obtain a target region image;
performing inpainting processing on the target region image to obtain a region inpainting image;
acquiring a difference image between the region inpainting image and the target region image; and
obtaining a target image based on the difference image and the original image.

14. The method according to claim 13, wherein the identifying the target object in the original image to obtain the target region image comprises:
detecting the target object in the original image;
generating an initial region image based on an image region where the target object is located;
detecting key points in the initial region image to obtain key point information; and
performing alignment processing on the target object based on the key point information to obtain the target region image.

15. The method according to claim 14, wherein the performing the alignment processing on the target object based on the key point information to obtain the target region image comprises:
rotating the initial region image based on the key point information; and
adjusting a size of the rotated initial region image to a preset size to obtain the target region image.

16. The method according to claim 13, wherein the performing inpainting processing on the target region image to obtain the region inpainting image comprises:
inputting the target region image into an image inpainting model to obtain the region inpainting image.

17. The method according to claim 13, wherein the acquiring the difference image between the region inpainting image and the target region image comprises:
performing difference processing on pixel values of the region inpainting image and the target region image based on a position of pixel points to obtain the difference image,
the pixel value comprising one or more of a RGB value, a UV value, and a brightness value.

18. The method according to claim 13, wherein the obtaining the target image based on the difference image and the original image comprises:
performing inverse rotation on the difference image;
adjusting a size of the inverse-rotated difference image to an original image size to obtain an adjusted difference image; and
fusing the adjusted difference image and the original image to obtain the target image.

19. The method according to claim 18, wherein the fusing the adjusted difference image and the original image to obtain the target image comprises:
performing addition processing on pixel values of the adjusted difference image and the original image based on a position of pixel points to obtain the target image;
the pixel value including one or more of a RGB value, a UV value, and a brightness value.

20. The method according to claim 13, wherein the original image is a high-resolution image or a super-resolution image.

21. An electronic device, comprising:
at least one processor; and
a memory for storing at least one processor-executable instructions;
wherein the at least one processor is configured to execute the instructions to implement acts comprising:
identifying a target object in an original image to obtain a target region image;
performing inpainting processing on the target region image to obtain a region inpainting image;
acquiring a difference image between the region inpainting image and the target region image; and
obtaining a target image based on the difference image and the original image.

22. The device according to claim 21, wherein the identifying the target object in the original image to obtain the target region image comprises:
detecting the target object in the original image;
generating an initial region image based on an image region where the target object is located;
detecting key points in the initial region image to obtain key point information; and
performing alignment processing on the target object based on the key point information to obtain the target region image.

23. The device according to claim 22, wherein the performing the alignment processing on the target object based on the key point information to obtain the target region image comprises:
rotating the initial region image based on the key point information; and
adjusting a size of the rotated initial region image to a preset size to obtain the target region image.

24. The device according to claim 21, wherein the performing inpainting processing on the target region image to obtain the region inpainting image comprises:
inputting the target region image into an image inpainting model to obtain the region inpainting image.

25. The device according to claim 21, wherein the acquiring the difference image between the region inpainting image and the target region image comprises:
performing difference processing on pixel values of the region inpainting image and the target region image based on a position of pixel points to obtain the difference image,
the pixel value comprising one or more of a RGB value, a UV value, and a brightness value.

26. The device according to claim 21, wherein the obtaining the target image based on the difference image and the original image comprises:
performing inverse rotation on the difference image;
adjusting a size of the inverse-rotated difference image to an original image size to obtain an adjusted difference image; and
fusing the adjusted difference image and the original image to obtain the target image.

27. The device according to claim 26, wherein the fusing the adjusted difference image and the original image to obtain the target image comprises:
performing addition processing on pixel values of the adjusted difference image and the original image based on a position of pixel points to obtain the target image;
the pixel value including one or more of a RGB value, a UV value, and a brightness value.

28. A non-transitory computer-readable storage medium, wherein when instructions in the computer-readable storage medium are executed by a processor of an electronic device, the electronic device is enabled to perform a method comprising:
identifying a target object in an original image to obtain a target region image;
performing inpainting processing on the target region image to obtain a region inpainting image;
acquiring a difference image between the region inpainting image and the target region image; and
obtaining a target image based on the difference image and the original image.

29. The storage medium according to claim 28, wherein the identifying the target object in the original image to obtain the target region image comprises:
detecting the target object in the original image;
generating an initial region image based on an image region where the target object is located;
detecting key points in the initial region image to obtain key point information; and
performing alignment processing on the target object based on the key point information to obtain the target region image.

30. The storage medium according to claim 28, wherein the performing inpainting processing on the target region image to obtain the region inpainting image comprises:
inputting the target region image into an image inpainting model to obtain the region inpainting image.

31. The storage medium according to claim 28, wherein the acquiring the difference image between the region inpainting image and the target region image comprises:
performing difference processing on pixel values of the region inpainting image and the target region image based on a position of pixel points to obtain the difference image,
the pixel value comprising one or more of a RGB value, a UV value, and a brightness value.

32. The storage medium according to claim 28, wherein the obtaining the target image based on the difference image and the original image comprises:
performing inverse rotation on the difference image;
adjusting a size of the inverse-rotated difference image to an original image size to obtain an adjusted difference image; and
fusing the adjusted difference image and the original image to obtain the target image.
